(19) United States
(12) Patent Application Publication
(10) Pub. No.: US 2025/0247122 A1
(43) Pub. Date: Jul. 31, 2025

(54) SOCKET WITH WATCH CHARGING FUNCTION

(71) Applicant: Guangdong Pisen Electronics Co., Ltd., Shenzhen City (CN)

(72) Inventors: Wu Zhao, Shenzhen City (CN); Yongchuan Zhang, Shenzhen City (CN)

(21) Appl. No.: 18/784,540

(22) Filed: Jul. 25, 2024

(30) Foreign Application Priority Data
Jan. 29, 2024 (CN) 2024202247915

(51) Int. Cl. H04B 1/3883; G04C 10/00; H01R 13/66; H02J 50/00; H02J 50/90; H04M 1/02

(52) U.S. Cl. CPC H04B 1/3883; H01R 13/6675; H02J 50/005; H04M 1/0274; G04C 10/00; H02J 50/90

(57) ABSTRACT

A socket with watch charging function is provided, including a socket body, wherein the socket body has a socket input end and a mains jack, and the socket body is further provided with a power module and a watch charger, wherein an input end of the power module is connected to the socket input end, an output end of the power module is connected to a power supply input end of the watch charger, for the power module to convert the mains electricity into adapted direct current to supply power to the watch charger, and the watch charger is used to charge an electronic watch.

### CROSS-REFERENCE TO RELATED APPLICATION

The present disclosure claims the priority to the Chinese Patent Application No. 2024202247915 filed on Jan. 29, 2024 with the China National Intellectual Property Administration and entitled “SOCKET WITH WATCH CHARGING FUNCTION”, the contents of which are incorporated by reference herein in entirety.

### TECHNICAL FIELD

The present disclosure relates to sockets, and specifically to a mains socket with watch charging function.

### BACKGROUND ART

Sockets or extension sockets, which are devices used in cooperation with plugs, include a socket body. The socket body usually has an insulating shell. A mains jack is provided on the shell, and a conductive metal sheet is provided inside the shell. The socket has an input end, usually a cable with a plug. The cable is connected with the conductive metal sheet inside the shell. When the socket is electrified, a plug of electrical equipment is connected to the jack, then the plug is in contact and conduction with the conductive metal sheet, allowing the electrical equipment to operate with electricity.

At present, various types of intelligent devices are increasingly popular. For example, the mobile phone, the tablet, and the smart watch have almost become standard household equipment. All of these devices need to be frequently charged. If the existing socket solutions are used, a plurality of chargers need to be connected to the socket, which will appear to be cluttered and messy and inconvenient to use.

### SUMMARY

The technical problem to be solved by the present disclosure is to provide a socket with its own watch charger that can charge a smart watch.

Technical solutions used in the present disclosure for solving the technical problem thereof are as follows.

A socket with watch charging function is provided, including a socket body, wherein the socket body has a socket input end for receiving mains electricity; and the socket body is provided with a mains jack for connecting a plug and transmitting the mains electricity to the plug.

The socket body is further provided with a power module and a watch charger. An input end of the power module is connected to the socket input end, an output end of the power module is connected to a power supply input end of the watch charger, for the power module to convert the mains electricity into adapted direct current so as to supply power to the watch charger. The watch charger is configured to charge an electronic watch.

Further, the watch charger is detachably connected to the socket body, and the power supply input end of the watch charger is further provided with a power supply interface for connecting an adapted direct-current power supply plug.

Further, the socket body is formed with a charger accommodating space, and the watch charger is detachably provided in the charger accommodating space.

The charger accommodating space is provided therein with a first contact, the output end of the power module is connected to the first contact, and the power supply input end of the watch charger is connected with a second contact.

The watch charger and the charger accommodating space are further provided with alignment portions, and when the watch charger is located in the charger accommodating space, the alignment portions limit a position of the watch charger, so that the first contact and the second contact are in correct contact and conduction, for realizing connection of the output end of the power module and the watch charger, and the power module supplies power to the watch charger.

Further, the watch charger is in a shape of a round cake, the power supply interface is located on a side wall of the round cake, and the second contact is located at a bottom of the round cake.

The charger accommodating space is a cup-shaped groove, the cup-shaped groove is adapted to the round cake, and the first contact bulges from a bottom surface in the cup-shaped groove.

The alignment portions include a first magnetic means located in the socket body and close to a position of the cup-shaped groove and a second magnetic means provided in the watch charger, and when the watch charger is located in the charger accommodating space and the first magnetic means and the second magnetic means are adsorbed to each other, the correct contact and conduction between the first contact and the second contact is realized, and the power supply interface is shielded by a side wall of the cup-shaped groove.

Further, the socket body is further provided with a mobile phone wireless charger. The output end of the power module is further connected to the mobile phone wireless charger, for the power module to convert the mains electricity into the adapted direct current so as to supply power to the mobile phone wireless charger. The mobile phone wireless charger is configured to wirelessly charge mobile phones.

Further, the watch charger is a wireless charger for wirelessly charging an electronic watch.

Further, the watch charger is located on an upper end surface of the socket body.

The mobile phone wireless charger covers an upper portion of the watch charger, and an edge of the mobile phone wireless charger is connected to the socket body through a hinge structure.

When the mobile phone wireless charger is rotated to an inclined state based on the hinge structure, the watch charger is exposed between the mobile phone wireless charger and the socket body.

The mobile phone wireless charger is further provided with a support portion for supporting a device being wirelessly charged and preventing it from slipping.

Further, the support portion is a magnetic component provided inside the mobile phone wireless charger, for adsorbing a device being wirelessly charged.

Further, a magnetic component is provided inside the watch charger, for adsorbing a device being wirelessly charged.

Further, the socket body is formed with a USB jack, and the output end of the power module is further connected to the USB jack for supplying direct current to a device connected to the USB jack. The socket body is in a shape of a square column, and a downward-facing surface of the socket body is provided with an anti-slip structure. The socket input end is a cable with a plug.

The beneficial effects of the present disclosure are as follows: the socket in the present solutions has the mains jack, similar to a common extension socket, and is further provided with the watch charger. The power module in the socket converts the mains electricity into the direct current to supply power to the watch charger. The watch can be charged without connecting an extra charger on the socket. In a preferred mode, the socket may also be hinged with a mobile phone wireless charger, wherein when the mobile phone wireless charger is rotated to an inclined state, it charges a mobile phone wirelessly and meanwhile may be used as a mobile phone holder, thereby facilitating watching videos on the mobile phone. The present socket is particularly suitable to be placed on a desk for use.

### BRIEF DESCRIPTION OF DRAWINGS

FIG. 1 is a perspective schematic diagram of an embodiment of a socket of the present disclosure;

FIG. 2 is a perspective schematic diagram of the embodiment of FIG. 1 from another viewing angle;

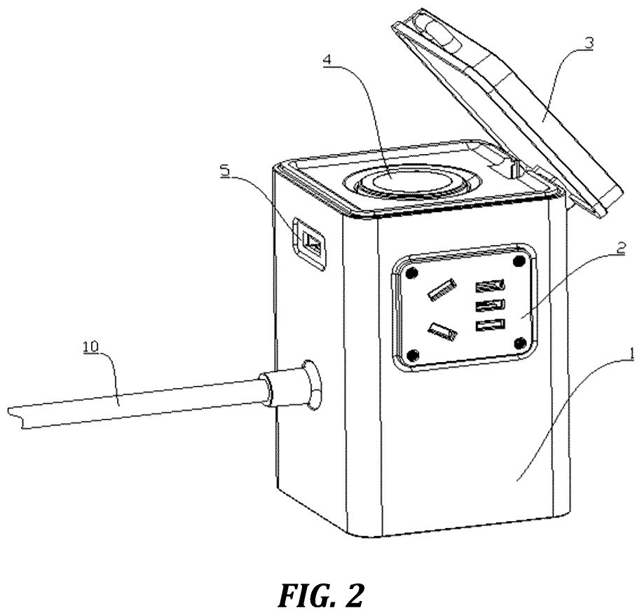

FIG. 3 is a perspective schematic diagram of the embodiment of FIG. 1 when a watch charger thereof is taken out; and

FIG. 4 is a perspective schematic diagram of the embodiment of FIG. 1 when the watch charger is taken out, from another viewing angle.

Reference signs in the drawings are: socket body 1, socket input end 10, charger accommodating space 11, first contact 12, mains jack 2, mobile phone wireless charger 3, hinge structure 31, watch charger 4, power supply interface 41, and USB jack 5.

### DETAILED DESCRIPTION OF EMBODIMENTS

The present disclosure is further described below in conjunction with drawings and embodiments, which typically may be as follows.

A socket with watch charging function, including a socket body 1, wherein the socket body 1 has a socket input end 10 for receiving mains electricity; and the socket body 1 is provided with a mains jack 2 for connecting a plug and transmitting the mains electricity to the plug.

The socket body 1 is further provided with a power module and a watch charger 4. An input end of the power module is connected with the socket input end 10, an output end of the power module is connected with a power supply input end of the watch charger 4, for the power module to convert the mains electricity into adapted direct current to supply power to the watch charger 4, and the watch charger 4 is used to charge an electronic watch.

The socket in the present solution, the same as common sockets, has the mains jack 2, and is further provided with the watch charger 4, so that it can charge a smart watch, and is suitable to be placed on a desk for use.

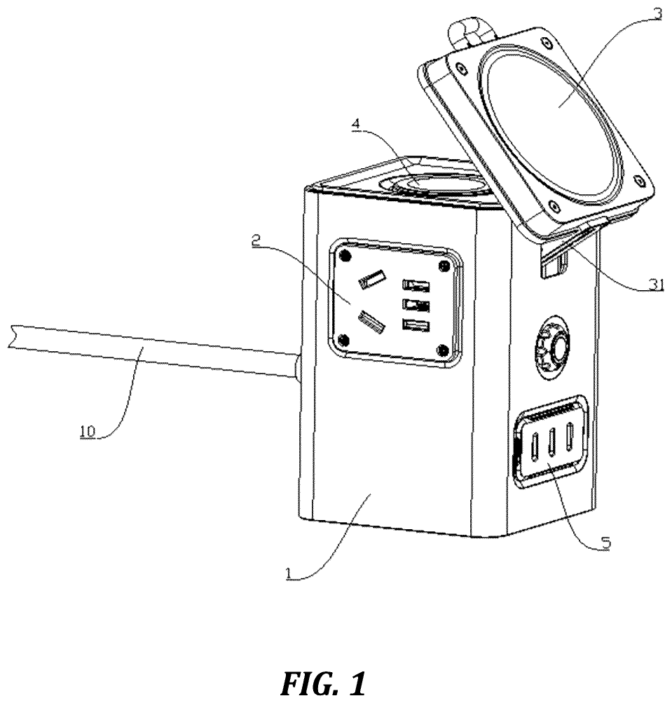

Specifically, as in FIGS. 1˜4, the mains jack 2 is located on the socket body 1, and a plug of electric appliance can be connected to the mains jack 2 to get electricity.

The socket input end 10 is used to receive the mains electricity. For example, the socket input end 10 may be a connection terminal, and when being used, needs to be connected to a mains supply line by a wire. Alternatively and preferably, the socket input end 10 may be a cable with a plug, and can be electrified and used just by being directly connected to a five-hole wall socket in a house.

The power module of the socket body 1 is used to convert the mains electricity into adapted direct current required by the charger, for example, 5-volt direct current or 9-volt direct current required by the general watch charger 4. Then the adapted direct current is converted by the power module to supply power to the watch charger 4, and a user may connect the smart watch or other electronic watches to the watch charger 4 provided in the present socket to charge.

The socket in the present solution is placed on a desk for use, the mains jack thereof can be used for connecting a table lamp or other electric appliances, and the built-in watch charger thereof may directly charge the smart watch, without connecting an extra charger to the socket.

The watch charger 4 may be connected to and charge the watch through a conductive contact or a charging interface, and may also charge the watch in a wireless charging manner, the principle thereof is the same as the charging principle in the prior art.

The watch charger 4 of the socket in the present solution may be fixedly provided on the socket body 1. It is also feasible that the watch charger 4 is detachably connected with the socket body 1. The power supply input end of the watch charger 4 is further provided with a power supply interface 41 for connecting an adapted direct-current power supply plug.

In the present preferred mode, when the watch charger 4 is connected to the socket body 1, the power module of the socket supplies power to the watch charger 4. According to needs, the watch charger 4 may be detached from the socket body 1 and used independently, and in this case, another charger is connected to the power supply interface 41 thereof to supply power thereto.

The watch charger 4 may be detachably connected with the socket body 1 through a plug and a socket. For example, the socket body I has a protruding type c male connector, the watch charger 4 has a type c female socket, an output end of the power module is connected to the type c male connector, and when the female socket of the watch charger 4 is connected to the type c male connector, power supply is available.

When the watch charger 4 is removed from the socket, a plug of a mobile phone charger can be connected to the type c female socket of the watch charger to supply power thereto.

More preferably, a space for accommodating the watch charger may be specially provided in the socket body 1.

For example, the socket body I may have a charger accommodating space 11, and the watch charger 4 is detachably provided in the charger accommodating space 11.

The charger accommodating space 11 is provided therein with a first contact 12, the output end of the power module is connected with the first contact 12, and the power supply input end of the watch charger 4 is connected with a second contact.

The watch charger 4 and the charger accommodating space 11 are further provided with alignment portions. When the watch charger 4 is located in the charger accommodating space 11, the alignment portions limit a position of the watch charger 4, so that the first contact 12 and the second contact are in correct contact and conduction, for realizing the connection of the output end of the power module with the watch charger 4, and the power module supplies power to the watch charger 4.

As shown in FIGS. 1˜4, the watch charger 4 may be placed in the charger accommodating space 11, so that the watch charger 4 is accommodated in the socket body, forming an integral body, which is more aesthetic and concise.

In the present preferred solution, the watch charger 4 is electrically connected with the power module through the contact and conduction of the contacts, that is, when the watch charger 4 is placed in the charger accommodating space 11, the first contact 12 and the second contact are in contact and conduction.

The alignment portions are used to limit the position of the watch charger 4 in the charger accommodating space 11, so as to ensure correct contact and conduction of the contacts.

The so-called correct contact and conduction of the contacts means that the output end of the power module is correctly connected with the power supply input end of the watch charger 4, so that the power module supplies power to the watch charger 4. For example, a positive electrode contact on the socket is in contact and conduction with a positive electrode contact of the watch charger, and a negative electrode contact on the socket is in contact and conduction with a negative electrode contact of the watch charger.

The alignment portions may be specifically implemented by, for example, having a sliding groove-sliding block structure. A sliding groove with a trapezoidal cross section is provided on an inner wall of the charger accommodating space 11, a sliding block with an adapted shape is provided on a periphery of the watch charger 4, and only when the sliding block is embedded into the sliding groove, the first contact 12 and the second contact can be in correct contact and conduction, and then the power module can supply power to the watch charger 4.

More preferably, magnetic means may be used to implement the function of the alignment portions. For example, the watch charger 4 may be in a shape of a round cake, the power supply interface 41 is located on a side wall of the round cake, and the second contact is located at a bottom of the round cake.

The charger accommodating space 11 is a cup-shaped groove, the cup-shaped groove is adapted to the round cake, and the first contact 12 bulges from a bottom surface in the cup-shaped groove.

The alignment portions include a first magnetic means and a second magnetic means. The first magnetic means is located in the socket body 1 and is close to a position where the cup-shaped groove is located. The second magnetic means is provided in the watch charger 4. When the watch charger 4 is located in the charger accommodating space 11, and the first magnetic means and the second magnetic means are adsorbed to each other, correct contact and conduction between the first contact 12 and the second contact is realized, and the power supply interface 41 is shielded by a side wall of the cup-shaped groove.

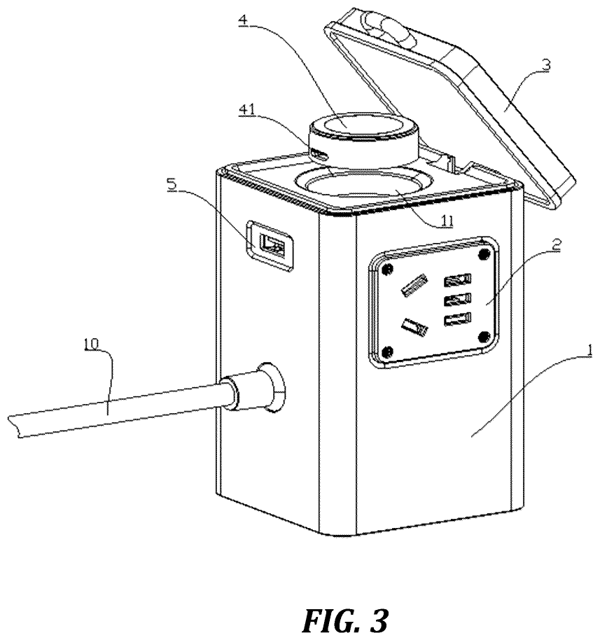

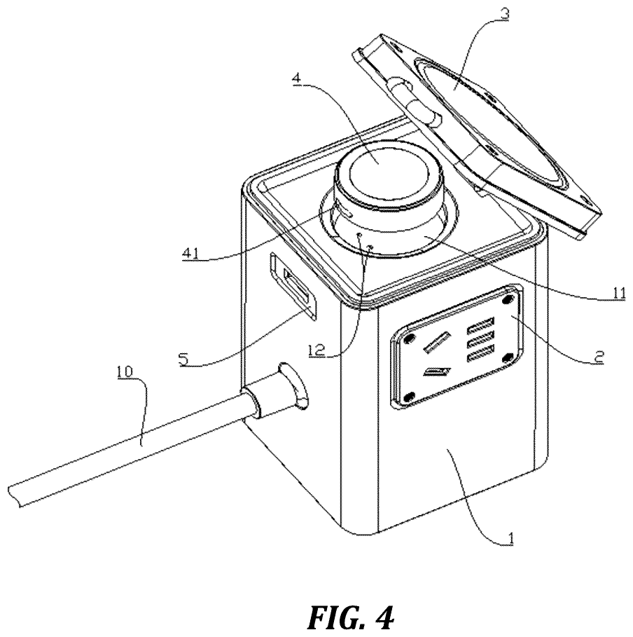

As shown in FIG. 3 and FIG. 4, in this embodiment, the watch charger 4 is in the shape of round cake, and the second contact is located at the bottom of the round cake; the charger accommodating space 11 is the adapted cup-shaped groove, and the first contact 12 bulges from the bottom surface of the cup-shaped groove.

The first magnetic means is located in the socket body 1, and the second magnetic means is located in the watch charger 4. When the watch charger 4 is put in the charger accommodating space 11, the first magnetic means and the second magnetic means, due to attraction of magnetic force, limit the watch charger 4 to be located in a correct position in the charger accommodating space 11, that is, a position where the first contact 12 and the second contact can be in correct contact and conduction.

The watch charger 4 is magnetically adsorbed in the charger accommodating space 11, and the power supply interface 41 thereof is just shielded by the side wall of the cup-shaped groove. In this case, the power supply interface 41 cannot be connected with the charger, and the watch charger 4 is powered solely by the power module of the socket.

In the above solution, the magnetic means are used to realize the function of the alignment portions, so that the watch charger 4 may be more conveniently mounted on or removed from the socket body.

More preferably, it is feasible that the socket body 1 is further provided with a mobile phone wireless charger 3. The output end of the power module is further connected with the mobile phone wireless charger 3, for the power module to convert the mains electricity into the adapted direct current to supply power to the mobile phone wireless charger 3. Moreover, the mobile phone wireless charger 3 is used to wirelessly charge mobile phones.

In the present solution, the socket body 1 is further provided with the mobile phone wireless charger 3, which may wirelessly charge electronic products such as mobile phones and tablets. The power module is responsible for converting the mains electricity into the adapted direct current to supply power to the mobile phone wireless charger 3. For example, a power supply voltage currently required by typical mobile phone wireless chargers is 5-volt or 9-volt direct current.

According to needs, the mobile phone wireless charger 3 may be provided in any position of the socket body 1, preferably, an upper portion of the socket body 1, for example, the watch charger 4 may be located on an upper end surface of the socket body 1.

The mobile phone wireless charger 3 covers an upper portion of the watch charger 4, and an edge of the mobile phone wireless charger 3 is connected with the socket body 1 through a hinge structure 31.

When the mobile phone wireless charger 3 is rotated to an inclined state based on the hinge structure 31, the watch charger 4 is exposed between the mobile phone wireless charger 3 and the socket body 1.

The mobile phone wireless charger 3 is further provided with a support portion for supporting a device being wirelessly charged and preventing it from slipping.

As shown in FIGS. 1 4, the mobile phone wireless charger 3 may be rotated based on the hinge structure 31, and when the mobile phone wireless charger 3 is rotated to the inclined state, the watch charger 4 is exposed between the mobile phone wireless charger 3 and the socket body 1, and can be connected with the watch for charging.

It is also possible to put the mobile phone on the mobile phone wireless charger 3 to be wirelessly charged, and when the mobile phone wireless charger 3 is in the inclined state, it is prevented from falling off due to the support portion.

The most typical support portion may be a convex structure perpendicular to a surface of the mobile phone wireless charger 3, located at a lower edge when the mobile phone wireless charger 3 is inclined.

When the mobile phone wireless charger 3 is in the inclined state, the mobile phone may be placed in a position between the surface of the mobile phone wireless charger 3 and the convex structure, so as to support the mobile phone and prevent it from falling off.

In this case, the socket is equivalent to a mobile phone holder, and can support oblique placement of the mobile phone while wirelessly charging, thereby facilitating watching videos. The socket is suitable to be placed on a desk for use.

More preferably, the support portion may be a magnetic component provided inside the mobile phone wireless charger 3, for adsorbing a device being wirelessly charged.

In the present preferred solution, the magnetic component is used to adsorb the mobile phone to the surface of the mobile phone wireless charger 3, and when the mobile phone wireless charger 3 is in the inclined state, the mobile phone likewise can be prevented from falling off.

Similarly, a magnetic component may also be provided inside the watch charger 4, for adsorbing a device being wirelessly charged. That is, the watch is stably adsorbed to the surface of the watch charger 4 by a magnetic force.

In addition, the socket in the present solution further may be provided with a USB charging port; for example, the socket body 1 is provided with a USB jack 5, and the output end of the power module is further connected to the USB jack 5 for supplying direct current to a device connected to the USB jack 5. The charging cable may be directly connected to the USB jack, and then charge the electronic device, without connecting a charger into the socket.

With regard to the socket in the present solution, the socket body 1 may be in a shape of square column or in other shapes that are aesthetic and convenient for placement, and a downward-facing surface of the socket body 1 further may be provided with an anti-slip structure.

What is claimed is:

1. A socket with watch charging function, comprising a socket body, wherein the socket body has a socket input end for receiving mains electricity; and the socket body is provided with a mains jack for connecting a plug and transmitting the mains electricity to the plug,
wherein the socket body is further provided with a power module and a watch charger, an input end of the power module is connected to the socket input end, an output end of the power module is connected to a power supply input end of the watch charger, for the power module to convert the mains electricity into adapted direct current so as to supply power to the watch charger, and the watch charger is configured to charge an electronic watch.

2. The socket with watch charging function according to claim 1, wherein the watch charger is detachably connected to the socket body, and the power supply input end of the watch charger is further provided with a power supply interface for connecting an adapted direct-current power supply plug.

3. The socket with watch charging function according to claim 2, wherein the socket body is formed with a charger accommodating space, and the watch charger is detachably provided in the charger accommodating space;
the charger accommodating space is provided therein with a first contact, the output end of the power module is connected to the first contact, and the power supply input end of the watch charger is connected with a second contact; and
the watch charger and the charger accommodating space are further provided with alignment portions, wherein when the watch charger is located in the charger accommodating space, the alignment portions limit a position of the watch charger, so that the first contact and the second contact are in correct contact and conduction, for realizing connection of the output end of the power module and the watch charger, and the power module supplies power to the watch charger.

4. The socket with watch charging function according to claim 3, wherein the watch charger is in a shape of a round cake, the power supply interface is located on a side wall of the round cake, and the second contact is located at a bottom of the round cake;
the charger accommodating space is a cup-shaped groove, the cup-shaped groove is adapted to the round cake, and the first contact bulges from a bottom surface in the cup-shaped groove; and
the alignment portions comprise: a first magnetic means located in the socket body and close to a position of the cup-shaped groove; and a second magnetic means provided in the watch charger, wherein when the watch charger is located in the charger accommodating space and the first magnetic means and the second magnetic means are adsorbed to each other, the correct contact and conduction between the first contact and the second contact is realized, and the power supply interface is shielded by a side wall of the cup-shaped groove.

5. The socket with watch charging function according to claim 1, wherein the socket body is further provided with a mobile phone wireless charger, the output end of the power module is further connected to the mobile phone wireless charger, for the power module to convert the mains electricity into the adapted direct current so as to supply power to the mobile phone wireless charger, and the mobile phone wireless charger is configured to wirelessly charge mobile phones.

6. The socket with watch charging function according to claim 5, wherein the watch charger is a wireless charger for wirelessly charging an electronic watch.

7. The socket with watch charging function according to claim 6, wherein the watch charger is located on an upper end surface of the socket body;
the mobile phone wireless charger covers an upper portion of the watch charger, and an edge of the mobile phone wireless charger is connected to the socket body through a hinge structure,
wherein when the mobile phone wireless charger is rotated to an inclined state based on the hinge structure, the watch charger is exposed between the mobile phone wireless charger and the socket body; and
the mobile phone wireless charger is further provided with a support portion for supporting a device being wirelessly charged and preventing it from slipping.

8. The socket with watch charging function according to claim 7, wherein the support portion is a magnetic component provided inside the mobile phone wireless charger, for adsorbing a device being wirelessly charged.

9. The socket with watch charging function according to claim 7, wherein a magnetic component is provided inside the watch charger, for adsorbing a device being wirelessly charged.

10. The socket with watch charging function according to claim 1, wherein the socket body is formed with a USB jack, the output end of the power module is further connected to the USB jack for supplying direct current to a device connected to the USB jack; the socket body is in a shape of a square column, and a downward-facing surface of the socket body is provided with an anti-slip structure; and the socket input end is a cable with a plug.

11. The socket with watch charging function according to claim 2, wherein the socket body is further provided with a mobile phone wireless charger, the output end of the power module is further connected to the mobile phone wireless charger, for the power module to convert the mains electricity into the adapted direct current so as to supply power to the mobile phone wireless charger, and the mobile phone wireless charger is configured to wirelessly charge mobile phones.

12. The socket with watch charging function according to claim 3, wherein the socket body is further provided with a mobile phone wireless charger, the output end of the power module is further connected to the mobile phone wireless charger, for the power module to convert the mains electricity into the adapted direct current so as to supply power to the mobile phone wireless charger, and the mobile phone wireless charger is configured to wirelessly charge mobile phones.

13. The socket with watch charging function according to claim 4, wherein the socket body is further provided with a mobile phone wireless charger, the output end of the power module is further connected to the mobile phone wireless charger, for the power module to convert the mains electricity into the adapted direct current so as to supply power to the mobile phone wireless charger, and the mobile phone wireless charger is configured to wirelessly charge mobile phones.
